(19) United States
(12) Patent Application Publication
(10) Pub. No.: US 2024/0188603 A1
(43) Pub. Date: Jun. 13, 2024

(54) METHOD FOR PRODUCING FROZEN COOKED RICE FOOD

(71) Applicant: NICHIREI FOODS INC., Tokyo-to (JP)

(72) Inventors: Jiro KITAMURA, Tokyo-to (JP); Akiko SAWADA, Tokyo-to (JP); Masao SAWADA, Tokyo-to (JP); Masaru SEKIGUCHI, Tokyo-to (JP)

(73) Assignee: NICHIREI FOODS INC., Tokyo-to (JP)

(21) Appl. No.: 18/285,207

(22) PCT Filed: Mar. 24, 2022
(86) PCT No.: PCT/JP2022/014188

§ 371 Date: Sep. 29, 2023

(30) Foreign Application Priority Data
Mar. 31, 2021 (JP) 2021-062125

(51) Int. Cl. A23L 7/143

(52) U.S. Cl. CPC A23L 7/143

(57) ABSTRACT

A method for producing a frozen cooked rice food is disclosed. This method includes:
(A) a step of cooking raw material rice to obtain cooked rice;
(B) a step of cooling the surface of the rice cooked in step (A) to a temperature in the range of −1 to 45° C.;
(C) a step of loosening the cooked rice while bringing steam into contact with the cooked rice cooled in step (B) to attach water to the cooked rice in an amount of 2 to 11 mass % with respect to the mass of the cooked rice; and
(D) a step of freezing the cooked rice obtained in step (C). This method is useful as a method for satisfactory separate freezing of frozen cooked rice in the production of frozen cooked rice.

### CROSS REFERENCE TO RELATED APPLICATIONS

The present patent application claims priority based on Japanese Patent Application No. 2021-062125 (filing date: Mar. 31, 2021). The whole disclosures of the earlier patent application are hereby incorporated by reference as a part of this description.

### TECHNICAL FIELD

The present disclosure relates to a method for producing frozen cooked rice food.

### BACKGROUND ART

Traditionally, cooked rice for freezing has been produced by various methods, and when freezing cooked rice, there has been adopted a method of making the rice easily separable by use of additives, oils and fats, etc., dropping and spreading the rice on a conveyor, and then applying physical force to the rice for separate freezing. Specifically, as an example, before freezing, the cooked rice is leveled on a conveyer, and after freezing, the cooked rice is cracked with stirring teeth or the like to separate the rice grains one by one. Even though this method separates the rice grains, the rice grains are crushed and cracked to be tattered, which does not give a soft appearance and a plump texture. In addition, the use of additives and oils and fats affects the taste and flavor of rice, and is a factor of deteriorating the quality of rice, which effect is remarkable especially when cooked white rice is eaten as it is.

Therefore, the development of a method for separate freezing of frozen cooked rice food is underway, which uses neither additives nor fats and oils and is different from the method of physically breaking and separating into pieces.

For example, PTL 1 discloses a method for producing separated frozen cooked rice food using a coating liquid.

However, there is still a demand for a frozen cooked rice food and a method for producing the same that can achieve separate freezing in a more satisfactory condition without using additives or fats and oils.

### CITATION LIST

### Patent Literature

[PTL 1] Japanese Unexamined Patent Application Publication No. 2005-192475

### SUMMARY OF INVENTION

The present disclosure provides a frozen cooked rice food which has an improved state of separating when the cooked rice food is prepared and then frozen, and a method for producing the same.

The present disclosers have found out a method for producing frozen cooked rice food, comprising: (A) a step of cooking raw material rice to obtain cooked rice; (B) a step of cooling the surface of the cooked rice cooked in step (A) to a temperature in the range of −1 to 45° C.; (C) a step of loosening the cooked rice while bringing steam into contact with the cooked rice cooled in step (B) to attach water to the cooked rice in an amount of 2 to 11 mass % with respect to the mass of the cooked rice; and (D) a step of freezing the cooked rice obtained in step (C).

### DESCRIPTION OF EMBODIMENTS

According to one embodiment of the present disclosure, a method for producing a frozen cooked rice food includes: (A) a step of cooking raw material rice to obtain cooked rice; (B) a step of cooling the surface of the cooked rice cooked in step (A) to a temperature in the range of −1 to 45° C.; (C) a step of loosening the cooked rice while bringing steam into contact with the cooked rice cooled in step (B) to attach water to the cooked rice in an amount of 2 to 11 mass % with respect to the mass of the cooked rice; and (D) a step of freezing the cooked rice obtained in step (C). The method of the present disclosure enables satisfactory separate freezing of frozen cooked rice even if additives or oils and fats are not used or used in a reduced amount, and thus enables preparation of frozen cooked rice without degrading the quality such as the flavor of the rice, which is an advantage of the method of the present disclosure.

In the present disclosure, rice as raw material (raw material rice) refers to rice after threshing or removing rice husks, and before being immersed in water. The raw material rice is not particularly limited as long as it is used as a raw material for cooked rice food, and variety of rice, presence or absence of milling, degree of polishing, and the like can be appropriately selected depending on the desired type of cooked rice food. There can be used rice varieties, such as Japonica rice and Indica rice, and Japonica rice is preferable as the raw material rice in the present disclosure. In addition, non-glutinous rice can be used as raw material rice in the present disclosure. Further, the amylose content of the raw material rice in the present disclosure (percentage of amylose in the total amount of starch contained in rice) is preferably 9 mass % or more. Further, there can be used any of the followings: rice before milling (so-called brown rice), rice with germs left (so-called germ rice), and rice after milling (so-called polished rice). Further, the raw material rice may be mixed with grains other than rice as long as the effect of the present invention is not impaired. Examples of grains other than rice include wheat, barley (such as rolled barley, barley rice grain, glutinous barley, etc.), adlay, foxtail millet, Japanese millet, millet, black sesame, and white sesame.

The raw material rice is subjected to pretreatment, such as washing and immersing, as necessary, before the heat cooking step. For example, raw material rice is washed with water, immersed in water for 1 hour or more, drained, and then subjected to heat cooking such as rice cooking. In the present disclosure, “cooking rice” may include not only heat cooking by rice cooking (cooking in a cooker), but also cooking by a steamer (household use), a rice steaming apparatus (industrial use), or the like.

Cooking of raw material rice is carried out according to a conventional method, and is carried out by heating the raw material rice in a state of being immersed in water.

The device for cooking raw material rice is not particularly limited as long as the effect of the present disclosure is exhibited, and a well-known rice cooking device for either industrial use or home use can be used.

In the present disclosure, cooked rice refers to rice cooked from raw material rice, and includes not only cooked rice obtained by cooking polished rice and brown rice, but also barley rice obtained by cooking polished rice with barley. The raw material rice in the present disclosure is preferably raw rice and polished rice, and more preferably non-glutinous polished rice. In the present disclosure, cooked rice refers to food that is neither seasoned nor processed, and thus frozen cooked rice food in the present disclosure refers to frozen food of cooked rice that is neither seasoned nor processed. The cooked rice in the present disclosure is preferably cooked white rice obtained by cooking polished rice.

In the production method of the present disclosure, the surface of cooked rice is cooled to a temperature in the range of −1 to 45° C.. The cooling temperature is not particularly limited as long as in the range of −1 to 45° C., preferably in the range of −1 to 20° C., and more preferably in the range of −1 to 10° C..

In the production method of the present disclosure, 2 to 11 mass % of water with respect to the mass of the cooked rice is attached to the cooked rice by bringing steam into contact with the cooled cooked rice. The mass ratio of the water to be attached to the cooked rice is not particularly limited as long as in the range of 2 to 11 mass % with respect to the mass of the cooked rice, preferably in the range of 2 to 7 mass %, and more preferably 3 to 6 mass %.

In the production method of the present disclosure, “steam” is not particularly limited as long as the effects of the present disclosure are exhibited, and is preferably water vapor.

The above mass ratio refers to the mass ratio of water actually attached to the cooled cooked rice from steam. For example, though not limited thereto, when 5 g of water attaches to 100 g of cooled cooked rice to make 105 g of cooled cooked rice, the mass ratio of water with respect to the mass of cooked rice is 5 mass %.

In the production method of the present disclosure, the “step of loosening the cooked rice while bringing steam into contact with the cooked rice” is not particularly limited as long as the effect of the present disclosure is exhibited, and is a step of generating dew condensation on the surface of the cooled cooked rice grains by bringing steam into contact with the cooked rice and loosening the cooked rice while maintaining the dew-condensed state, and preferably, for example, a step of loosening the cooked rice while spraying steam.

The pressure for spraying the steam may be adjusted within a range that allows the specified amount of water to attach to the surface of the cooled cooked rice, and, for example, though not limited thereto, is in the range of 0.1 to 0.5 MPa.

The difference between the surface temperature of the cooled cooked rice and the temperature of the sprayed steam is not limited, and is preferably, for example, in the range of 60 to 101° C.

In the production method of the present disclosure, the “step of loosening the cooked rice” is not particularly limited as long as the effect of the present disclosure is exhibited, and examples thereof include a step of loosening the cooked rice by bringing stirring sticks, comb teeth, rotary teeth, or the like into physical contact with the cooked rice; a step of loosening the cooked rice by vibration of a vibration conveyor or the like; a step of loosening the cooked rice while being stirred by rotation in a rotating container; a step of loosening the cooked rice by a fall at a connection between two conveyors or the like; a step of loosening cooked rice by applying pressure with air; and the like. The above steps may be performed singly or in combination. In the production method of the present disclosure, the “step of loosening the cooked rice” include neither a step of kneading the cooked rice nor a step of crushing the cooked rice. In addition, in the production method of the present disclosure, physical parameters such as frequency of vibration, number of rotations, air pressure, etc. may be adjusted within a range that enables separate freezing. In the production method of the present disclosure, the “step of loosening the cooked rice” is preferably one or more steps selected from following steps: a step of loosening the cooked rice with a spatula, a stick, and/or comb teeth equipped with a stirring mechanism and/or a rotating mechanism; a step of loosening the cooked rice with a conveying device equipped with a vibrating mechanism; a step of loosening the cooked rice by a fall at a connection to a succeeding conveying device during transfer by the conveying devices; and a step of loosening the cooked rice by air pressure.

In the production method of the present disclosure, the “step of loosening the cooked rice” is not particularly limited as long as the effect of the present disclosure is exhibited, and is preferably a step of loosening the cooked rice after spreading or while spreading the cooked rice to be 100 g per space of area (100 to 300 cm²)×height (0.1 to 3.0 cm).

In the production method of the present disclosure, a specified amount of steam is brought into contact with the cooled cooked rice to cause dew condensation on the surface of the rice grains of the cooled cooked rice, the cooked rice is loosened while maintaining the dew-condensed state, and the resulting cooked rice is frozen. As a result, the above cooked rice forms multiple-grain agglomerates in which a single grain of cooked rice and a plurality of cooked rice grains are connected to each other, and can be frozen in the form of such multiple-grain agglomerate.

In the production method of the present disclosure, in order to serve the cooked rice neatly in a rice bowl, the multiple-grain agglomerate preferably has a long axis of 46 mm or less. Further, in the production method of the present disclosure, the multiple-grain agglomerate preferably has a weight of 10 g or less, and more preferably 8.7 g or less.

In the present disclosure, the multiple-grain agglomerate preferably has 229 grains or less per agglomerate, and more preferably 199 grains or less.

Thus obtained multiple-grain agglomerates are preferably that 60% or more of the whole cooked rice grains are contained in the multiple-grain agglomerates of 26 or more grains, and 90% or more of the whole cooked rice grains are contained in the multiple-grain agglomerates of 100 or less grains.

In the production method of the present disclosure, well-known methods can be used as a method for freezing the cooked rice food, and the method can be appropriately selected depending on the type of the cooked rice food. Preferably, the cooked rice food can be obtained in a frozen food form by rapidly freezing at −30° C. or lower. Further, the obtained frozen food is stored at −15° C. or lower, preferably −18° C. or lower.

The frozen cooked rice food of the present disclosure can be served as a meal through various heat treatments using a microwave oven, a frying pan, a hot water bath, and the like.

Further, according to an embodiment of the present disclosure, the following (1) to (8) can be provided.

(1) A method for producing a frozen cooked rice food, comprising:
(A) a step of cooking raw material rice to obtain cooked rice;
(B) a step of cooling the surface of the rice cooked in step (A) to a temperature in the range of −1 to 45° C.;
(C) a step of loosening the cooked rice while bringing steam into contact with the cooked rice cooled in step (B) to attach water to the cooked rice in an amount of 2 to 11 mass % with respect to the mass of the cooked rice; and
(D) a step of freezing the cooked rice obtained in step (C).

(2) The method according to (1), wherein the cooked rice obtained in step (A) is cooked white rice.

(3) The method according to (1) or (2), wherein the temperature for cooling the surface of the cooked rice in step (B) is within the range of −1 to 20° C.

(4) The method according to any one of (1) to (3), wherein the steam brought into contact in step (C) is water vapor.

(5) The method according to any one of (1) to (4), wherein the step of loosening the cooked rice in step (C) is one or more steps selected from following steps: a step of loosening the cooked rice with a spatula, a stick, and/or comb teeth equipped with a stirring mechanism and/or a rotating mechanism; a step of loosening the cooked rice with a conveying device equipped with a vibrating mechanism; a step of loosening the cooked rice by a fall at a connection to a succeeding conveying device during transfer by the conveying devices; and a step of loosening the cooked rice by air pressure.

(6) The method according to any one of (1) to (5), wherein the step of loosening the cooked rice while bringing steam into contact in step (C) is a step of loosening the cooked rice while spraying steam.

(7) The method according to any one of (1) to (6), wherein the step of loosening the cooked rice in step (C) is a step of loosening the cooked rice after spreading or while spreading the cooked rice to be 100 g per space of area (100 to 300 cm²)×height (0.1 to 3.0 cm).

(8) The method according to any one of (1) to (7), wherein the mass of water attached to the cooked rice in step (C) is 2 to 7 mass % with respect to the mass of the cooked rice.

### EXAMPLES

Hereinafter, the present disclosure will be specifically described, but the present disclosure is not limited to these examples. Unless otherwise specified, units and measurement methods conform to Japanese Industrial Standards (JIS).

Polished rice (600 g) was prepared, washed by normal operation, immersed in water for 1 hour or more, with addition of water to the total amount of 1350 g with polished rice and water, and cooked with an IH rice cooker. The cooked rice (300 g) was spread on a mesh (inside diameter: 2 mm, gridded) to about 600 cm² (about 1.5-cm thick), cooled in a refrigerator to 10° C. or lower, and was loosened by breaking vertically with a rubber spatula while being sprayed with steam (5 mass %) by using a steam cleaner SC4 EasyFix (max. discharge pressure: 0.35 MPa, sprayed steam weight: about 1.1 g/sec) (manufactured by Kärcher). At this step, while the moisture of the steam was spread among the grains of the cooked rice, the cooked rice was loosened with a rubber spatula so as not to crush the rice grain. After that, the rice was transferred to a vat and subjected to rapid freeze/refrigeration.

The frozen rice (250 g) was weighed out, and the distribution state of the multiple-grain agglomerates was measured. The results are shown below.

Multiple-grain agglomerates are distributed as follows with respect to the total number of cooked rice grains: 90% or more are as 3 grains or more, 80% or more as 6 grains or more, 70% or more as 12 grains or more, and 60% or more as 26 grains or more. In addition, multiple-grain agglomerates are distributed as follows with respect to the total number of cooked rice grains: 90% or more as 100 grains or less, 80% or more as 77 grains or less, 70% or more as 60 grains or less, and 60% or more as 53 grains or less.

Polished rice (600 g) was prepared, washed by normal operation, immersed in water for 1 hour or more, with addition of water to the total amount of 1350 g with polished rice and water, and cooked with an IH rice cooker. The cooked rice (300 g) was spread on a mesh (inside diameter: 2 mm, gridded) to about 600 cm² (about 1.5-cm thick), cooled in a refrigerator to −3 to 45° C. or lower, and was loosened by breaking vertically with a rubber spatula while being sprayed with steam (1 to 11 mass %) by using a steam cleaner SC4 EasyFix (max. discharge pressure: 0.35 MPa, sprayed steam weight: about 1.1 g/sec) (manufactured by Kärcher). At this step, while the moisture of the steam was spread among the grains of the cooked rice, the cooked rice was loosened with a rubber spatula so as not to crush the rice grain. After that, the rice was transferred to a vat and subjected to rapid freeze/refrigeration. The frozen rice (150 g) was placed in a rice bowl, lightly covered with wrap film, heated in a microwave oven at 600 W for 2 minutes, and then good or bad of the separated state was evaluated. The separated state was determined as follows in terms of length of a long axis of multiple-grain agglomerate: good for 46 mm or less, and bad for 47 mm or more.

For comparison, instead of spraying steam, two samples of cold water-sprayed cooked rice and hot water-sprayed cooked rice were prepared. Cooked rice was spread on a mesh (inside diameter: 2 mm, gridded) and cooled in a refrigerator to 10° C. or lower. The cooked rice samples were prepared by being loosened with a spatula separately while spraying cold water of 20° C. and while spraying hot water of 90° C.. After that, the rice was transferred to a vat and subjected to rapid freeze/refrigeration. The frozen rice (150 g) was placed in a rice bowl, lightly covered with wrap film, heated in a microwave oven at 600 W for 2 minutes, and then subjected to the test.

For comparison, cooked rice was prepared using dry ice instead of steam. The cooked rice (300 g) spread on a mesh was sprayed with snow dry ice for 10 seconds to obtain agglomerates with a long axis of 47 mm or more. In addition, while spraying snow dry ice, loosened cooked rice (300 g) was scattered and dropped over 10 seconds to obtain large agglomerates with a long axis of 47 mm or more.

The results are shown in Tables 1 to 4. Multiple-grain agglomerates, when being not well separated to have a long axis of 47 mm or more and a weight of 10.3 g or more, could not be neatly served in a rice bowl. On the other hand, multiple-grain agglomerates, when having a long axis of 46 mm or less and a weight of 8.7 g or less, could be neatly served in a rice bowl.

TABLE 1
Evaluation results (Examples 1 to 6)

| | Ex 1 | Ex 2 | Ex 3 | Ex 4 | Ex 5 | Ex 6 |
|---|---|---|---|---|---|---|
| Cooling | 10° C. | 20° C. | 40° C. | −1° C. | 10° C. | 10° C. |
| temperature of | | | | | | |
| cooked rice | | | | | | |
| Amount of | 5% | 5% | 5% | 5% | 2% | 3% |
| steam | | | | | | |
| Sprayed steam | 100° C. | 100° C. | 100° C. | 100° C. | 100° C. | 100° C. |
| temperature | | | | | | |
| Good or Bad of | Good | Good | Good | Good | Good | Good |
| separation* | | | | | | |

Ex: Example
*Length of long axis of multiple-grain agglomerate, 46 mm or less: Good, 47 mm or more: Bad

TABLE 2
Evaluation results (Examples 7 to 12)

| | Ex 7 | Ex 8 | Ex 9 | Ex 10 | Ex 11 | Ex 12 |
|---|---|---|---|---|---|---|
| Cooling | 10° C. | 10° C. | 10° C. | 10° C. | 10° C. | 10° C. |
| temperature of | | | | | | |
| cooked rice | | | | | | |
| Amount of | 4% | 6% | 7% | 8% | 9% | 10% |
| steam | | | | | | |
| Sprayed steam | 100° C. | 100° C. | 100° C. | 100° C. | 100° C. | 100° C. |
| temperature | | | | | | |
| Good or Bad of | Good | Good | Good | Good | Good | Good |
| separation* | | | | | | |

Ex: Example
*Length of long axis of multiple-grain agglomerate, 46 mm or less: Good, 47 mm or more: Bad

TABLE 3
Evaluation results (Examples 13 and
14 and Comparative examples 1 to 4)

| | Ex 13 | Ex 14 | Cex 1 | Cex 2 | Cex 3 | Cex 4 |
|---|---|---|---|---|---|---|
| Cooling | 45° C. | 10° C. | 10° C. | −3° C. | 10° C. | 10° C. |
| temperature of | | | | | | |
| cooked rice | | | | | | |
| Amount of | 5% | 11% | 1% | 5% | 5% | 5% |
| steam | | | | | | |
| Sprayed steam | 100° C. | 100° C. | 100° C. | 100° C. | — | — |
| temperature | | | | | | |
| Good or Bad of | Good | Good | Bad | Bad | Bad | Bad |
| separation* | | | | | | |
| Remarks | | | | | Use | Use |
| | | | | | cold | hot |
| | | | | | water | water |
| | | | | | of | of |
| | | | | | 20° C. | 90° C. |
| | | | | | instead | instead |
| | | | | | of | of |
| | | | | | steam | steam |

Ex: Example,
Cex: Comparative example
*Length of long axis of multiple-grain agglomerate, 46 mm or less: Good, 47 mm or more: Bad

TABLE 4
Evaluation results (Comparative examples 5 and 6)

| | Cex 5 | Cex 6 |
|---|---|---|
| Cooling | 10° C. | 10° C. |
| temperature of | | |
| cooked rice | | |
| Amount of steam | 166% | 166% |
| Sprayed steam | −78° C. | −78° C. |
| temperature | | |
| Good or Bad of | Bad | Bad |
| separation* | | |
| Remarks | Use dry | Feed |
| | ice to the | loosened |
| | spread | cooked |
| | rice | rice in the |
| | | sprayed |
| | | dry ice |

Cex: Comparative example
*Length of long axis of multiple-grain agglomerate, 46 mm or less: Good, 47 mm or more: Bad

From the above, the method of the present disclosure was shown to enable satisfactory separate freezing of frozen cooked rice. The frozen cooked rice with a steam content of 12% or more exhibited unsatisfactory separated state as compared to the frozen cooked rice obtained by the method of the present disclosure, and after heated in a microwave oven, became soft and too sticky due to high water content, and thus could not exhibit a satisfactory texture.

1. A method for producing a frozen cooked rice food, comprising:
(A) a step of cooking raw material rice to obtain cooked rice;
(B) a step of cooling the surface of the rice cooked in step (A) to a temperature in the range of −1 to 45° C.;
(C) a step of loosening the cooked rice while bringing steam into contact with the cooked rice cooled in step (B) to attach water to the cooked rice in an amount of 2 to 11 mass % with respect to the mass of the cooked rice; and
(D) a step of freezing the cooked rice obtained in step (C).

2. The method according to claim 1, wherein the cooked rice obtained in step (A) is cooked white rice.

3. The method according to claim 1, wherein the temperature for cooling the surface of the cooked rice in step (B) is within the range of −1 to 20° C.

4. The method according to claim 1, wherein the steam brought into contact in step (C) is water vapor.

5. The method according to claim 1, wherein the step of loosening the cooked rice in step (C) is one or more steps selected from following steps: a step of loosening the cooked rice with a spatula, a stick, and/or comb teeth equipped with a stirring mechanism and/or a rotating mechanism; a step of loosening the cooked rice with a conveying device equipped with a vibrating mechanism; a step of loosening the cooked rice by a fall at a connection to a succeeding conveying device during transfer by the conveying devices; and a step of loosening the cooked rice by air pressure.

6. The method according to claim 1, wherein the step of loosening the cooked rice while bringing steam into contact in step (C) is a step of loosening the cooked rice while spraying steam.

7. The method according to claim 1, wherein the step of loosening the cooked rice in step (C) is a step of loosening the cooked rice after spreading or while spreading the cooked rice to be 100 g per space of area (100 to 300 cm²)×height (0.1 to 3.0 cm).

8. The method according to claim 1, wherein the mass of water attached to the cooked rice in step (C) is 2 to 7 mass % with respect to the mass of the cooked rice.
